(19) United States
(12) Patent Application Publication
(10) Pub. No.: US 2014/0092498 A1
(43) Pub. Date: Apr. 3, 2014

(54) COLOR FILTER SUBSTRATE, ELECTRO-OPTICAL DEVICE, AND ELECTRONIC EQUIPMENT

(71) Applicant: Seiko Epson Corporation, Tokyo (JP)

(72) Inventor: Takehiro Ono, Chino-shi (JP)

(73) Assignee: Seiko Epson Corporation, Tokyo (JP)

(21) Appl. No.: 14/031,178

(22) Filed: Sep. 19, 2013

(30) Foreign Application Priority Data
Oct. 1, 2012 (JP) 2012-219139

(51) Int. Cl. G02B 5/20

(52) U.S. Cl. CPC G02B 5/201
USPC 359/891

(57) ABSTRACT

A color filter substrate includes a first color filter layer, a second color filter layer, and a light blocking portion that blocks light. The first color filter layer includes a first surface, a second surface opposing the first surface, and a side surface crossing the first surface and the second surface. An angle between the first surface and the side surface is an acute angle. The light passes in a direction toward the second surface from the first surface. The light blocking portion is disposed in such a manner as to be in contact with the side surface. A wall surface of the light blocking portion that is disposed in such a manner as to be in contact with the side surface reflects the light incident from the first surface so that the light is directed toward the second surface.

### BACKGROUND

1. Technical Field

The present invention relates to a color filter substrate, an electro-optical device including the color filter substrate, and electronic equipment including the electro-optical device.

2. Related Art

In the related art, an electro-optical device described in JP-A-2009-128742 is known as an example of a liquid crystal display device in which a gap between a color filter substrate and an element substrate is filled with liquid crystals. The electro-optical device described in JP-A-2009-128742 modulates light that is incident from the color filter substrate side by using the liquid crystals, and emits the light to a pixel opening area of the element substrate. The color filter substrate is configured in such a manner that red, green, and blue color layers (color filters) are embedded in a concave portion surrounded by a deflection projection which has an inclined reflective surface (wall surface). The deflection projection is formed of a light transmitting resin whose refractive index is lower than a refractive index of the color filter. The wall surface of the deflection projection reflects the light (incident light) that is incident upon the color filter substrate so that the light reaches the pixel opening area of the element substrate and utilization efficiency of the incident light is increased.

However, in the electro-optical device described in JP-A-2009-128742, the deflection projection is formed of the light transmitting resin, and thus there is a concern that the light might not be reflected by the wall surface of the deflection projection but passes through the deflection projection depending on an angle of the light that is incident upon the inclined surface of the deflection projection. For example, if the light that is incident upon the red color layer passes through the deflection projection to be incident upon the other, green and blue, color layers, mixing of the colors occurs, and color reproduction (contrast) is reduced. In this manner, in the electro-optical device described in JP-A-2009-128742, there is a concern that the color reproduction might be reduced depending on the angle of the light that is incident upon the wall surface of the deflection projection.

### SUMMARY

The invention can be realized in the following forms or application examples.

### Application Example 1

According to Application Example 1, there is provided a color filter substrate including: a first color filter layer; a second color filter layer; and a light blocking portion that blocks light, in which the first color filter layer has: a first surface; a second surface opposing the first surface; and a side surface crossing the first surface and the second surface, an angle between the first surface and the side surface is an acute angle, the light passes in a direction toward the second surface from the first surface, the light blocking portion is disposed in such a manner as to be in contact with the side surface, and a wall surface of the light blocking portion that is disposed in such a manner as to be in contact with the side surface reflects the light incident from the first surface so that the light is directed toward the second surface.

The light blocking portion that blocks the light is provided between the first color filter layer and the second color filter layer. The color filter layer includes the first surface where the light is incident, the second surface where the incident light is emitted, and a side surface crossing the first surface and the second surface. The wall surface of the light blocking portion is disposed in such a manner as to be in contact with the side surface of the color filter layer. Therefore, the wall surface has the same inclination as the side surface, forms an acute angle between the first surface and itself, and reflects the light that is incident from the first surface toward the second surface. The light that is directed from the first surface toward the second surface is display light which is observed by an observer, and the light that is reflected by the wall surface also is part of the display light observed by the observer. In other words, brightness of the display light observed by the observer can be increased by reflecting the light that is incident from the first surface of the color filter layer, using the wall surface, toward the second surface of the color filter layer.

### Application Example 2

In the color filter substrate according to Application Example 1, it is preferable that the light blocking portion include a third surface, a fourth surface opposing the third surface, and a wall surface crossing the third surface and the fourth surface, and the third surface be disposed between the first color filter layer and the second color filter layer.

The third surface and the wall surface of the light blocking portion are disposed between the first color filter layer and the second color filter layer, and the light that is incident upon the wall surface is reflected by the wall surface to become part of the display light observed by the observer. Therefore, the brightness of the display light may be increased.

Furthermore, an area (opening area) surrounded by the wall surface of the light blocking portion is filled with the color filter layer. In a case where a material forming the color filter layer overflows from the opening area during manufacturing of the color filter substrate, the material flows on a face of the fourth surface. The fourth surface, which is disposed opposite to the third surface, is wider than the third surface, and prevents the overflowing material of the color filter layer from flowing to an adjacent opening area. Therefore, color mixing in which the material of the color filter layer overflowing from the opening area is mixed with the adjacent material of the color filter layer may be prevented.

### Application Example 3

In the color filter substrate according to the above Application Examples, it is preferable that a substrate be disposed in such a manner as to be in contact with any one of the first surface and the second surface, and the substrate transmit light.

The light transmitting substrate is disposed in such a manner as to be in contact with any one of the first surface and the second surface of the color filter layer, and the substrate is a light transmitting base material that supports the color filter layer and the light blocking portion.

In a configuration in which the base material and the first surface are in contact with each other, the brightness of the display light (light in a direction from the first surface toward the second surface) observed by the observer may be increased by passing the light through the base material, causing the light to be incident upon the wall surface of the light blocking portion, and reflecting the light toward the second surface using the wall surface of the light blocking portion.

In a configuration in which the base material and the second surface are in contact with each other, the brightness of the display light (light in a direction from the first surface toward the second surface) observed by the observer may be increased by causing the light to be incident upon the wall surface of the light blocking portion from the first surface, reflecting the light toward the second surface using the wall surface of the light blocking portion, passing the light through the base material, and emitting the light toward the observer.

### Application Example 4

In the color filter substrate according to the above Application Examples, it is preferable that the wall surface include an area inclined at an angle of between 75° and 85° between the first surface and the wall surface.

In a case where the inclination of the wall surface is less than 75°, an area through which the light emitted toward the observer passes (area of the second surface of the color filter layer) is small, and there is a concern that the brightness of the light (display light) emitted from the second surface may be reduced. Also, in a case where the inclination of the wall surface is more than 85°, the amount of the light that is incident upon the wall surface is small, the reflective light that is reflected toward the second surface by the wall surface is weak, and it is difficult to increase the brightness of the display light using the reflective light. In other words, it is preferable that the inclination of the wall surface be between 75° and 85°. The brightness of the display light may be effectively increased by the light that is reflected by the wall surface inclined at the angle.

### Application Example 5

In the color filter substrate according to the above Application Examples, it is preferable that the light blocking portion be formed of aluminum.

Aluminum has excellent light reflectivity, and thus the brightness of the display light observed by the observer may be increased by reflecting the light, using the wall surface of the light blocking portion that is formed of aluminum, in a direction which is part of the display light.

### Application Example 6

In the color filter substrate according to the above Application Examples, it is preferable that the light blocking portion include a light blocking layer that blocks the light, and a low refractive index layer that has a refractive index which is lower than a refractive index of the first color filter layer and a refractive index of the second color filter layer.

The light blocking portion has a low refractive index layer whose refractive index is lower than a refractive index of the color filter layer, and reflection of the light occurs on an interface between the color filter layer and the low refractive index layer. The brightness of the display light may be increased by reflecting the reflected light in the direction which is part of the display light observed by the observer.

### Application Example 7

In the color filter substrate according to the above Application Examples, it is preferable that the substrate be formed of quartz, and the light blocking portion include a light blocking layer that blocks the light, and quartz formed by etching the substrate.

The low refractive index layer is formed of quartz that is integrated with the base material. Therefore, the color filter substrate may be provided with excellent mechanical strength and high reliability, with peeling of the low refractive index layer being prevented.

### Application Example 8

According to Application Example 8, there is provided an electro-optical device including the color filter substrate described in the above Application Examples.

The electro-optical device according to Application Example 8 includes the color filter substrate described in the above Application Examples. Therefore, the light reflected by the light blocking portion is also part of the display light, and thus brighter display may be provided.

### Application Example 9

According to Application Example 9, there is provided electronic equipment including the electro-optical device described in the above Application Examples.

The electronic equipment according to Application Example 9 includes the electro-optical device described in Application Example 8. Therefore, the brightness of the display light may be increased, and brighter display may be provided compared to a case where an electro-optical device manufactured using the related art is mounted. For example, the electro-optical device according to Application Example 8 may be applied to display portions of various electronic equipment, such as a head-mounted display (HMD), a digital camera, a mobile computer, a digital video camera, in-vehicle equipment, audio equipment, and information terminal equipment.

### BRIEF DESCRIPTION OF THE DRAWINGS

The invention will be described with reference to the accompanying drawings, wherein like numbers reference like elements.

FIG. 1 is a perspective view showing a configuration of a display device according to a first embodiment.

FIG. 2 is an equivalent circuit diagram showing an electrical configuration of a display area of the display device according to the first embodiment.

FIG. 3 is a cross-sectional view of a display panel taken along line III-III of the display area of FIG. 1.

FIG. 4 is a cross-sectional view of the display panel showing area IV surrounded by a dashed line of FIG. 3.

FIG. 5 is a cross-sectional view of a display device according to a second embodiment.

FIG. 6 is a perspective view showing a configuration of a display device according to a third embodiment.

FIG. 7 is an equivalent circuit diagram showing an electrical configuration of a display area of the display device according to the third embodiment.

FIG. 8 is a cross-sectional view of a display panel taken along line VIII-VIII of the display area of FIG. 6.

FIG. 9 is a cross-sectional view of the display panel showing area IX surrounded by a dashed line of FIG. 8.

FIG. 10 is a cross-sectional view showing a display device according to a first modification example.

FIG. 11A is a perspective view of a head-mounted display, and FIG. 11B is a schematic view showing an overview of a digital camera.

### DESCRIPTION OF EXEMPLARY EMBODIMENTS

Hereinafter, embodiments of the invention will be described referring to the accompanying drawings. The invention may, however, be embodied in different forms and should not be construed as limited to the embodiments set forth herein. The detailed description may be amended or modified within the scope of the technical idea of the invention. Also, in the respective drawings, the dimensions of layers and regions are exaggerated for clarity of illustration.

### First Embodiment

### Overview of Display Device

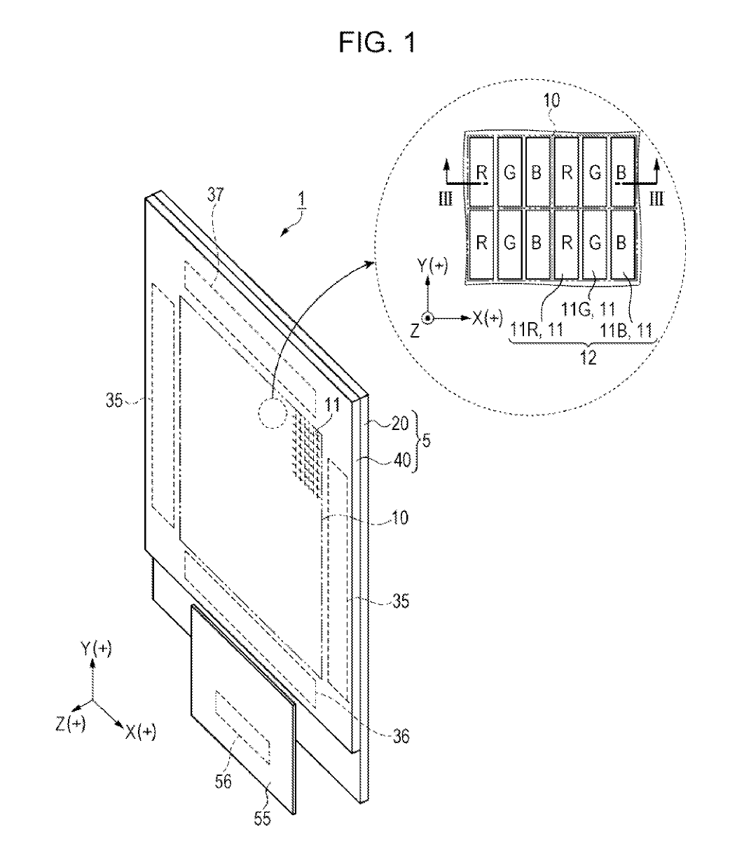

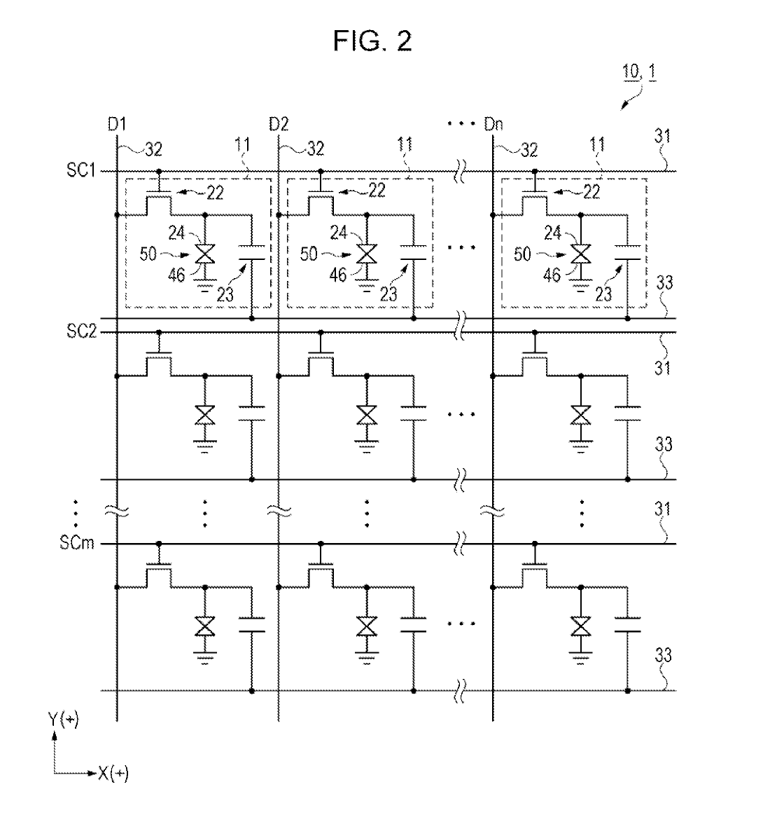

FIG. 1 is a perspective view showing a configuration of a display device according to a first embodiment. FIG. 2 is an equivalent circuit diagram showing an electrical configuration of a display area of the display device according to the first embodiment.

First, an overview of a display device 1 will be described referring to FIGS. 1 and 2.

The display device 1 according to the first embodiment, which is an example of an electro-optical device, is an active matrix type liquid crystal display device where pixels 11 are disposed in a matrix form. In FIG. 1, an area that is surrounded by a two-dot chain line is a display area 10 where the pixels 11 are disposed.

As shown in FIG. 1, the display device 1 includes a display panel 5, a flexible substrate 55, etc.

Hereinafter, a direction along one side of a face of the display panel 5 to which the flexible substrate 55 is attached is referred to as an X axis direction, a direction along the other two sides that cross the one side and oppose each other is referred to as a Y axis direction, and a thickness direction of the display panel 5, which is orthogonal to the X axis direction and the Y axis direction, is referred to as a Z axis direction.

As shown enlarged in the upper right section of FIG. 1, in the display area 10 that is provided in the display panel 5, the pixels (R pixels) 11R that correspond to the red color, the pixels (G pixels) 11G that correspond to the green color, and the pixels (B pixels) 11B that correspond to the blue color are arranged in such a manner as to form pixel arrays (striped arrays) of the same color in the Y axis direction. The three pixels 11 corresponding to the R pixel 11R, the G pixel 11G, and the B pixel 11B form a display unit 12 to provide full-color display.

Also, the invention is not limited to the striped color array described above. The color array in the Y axis direction may be a different array (for example, a mosaic array or a delta array).

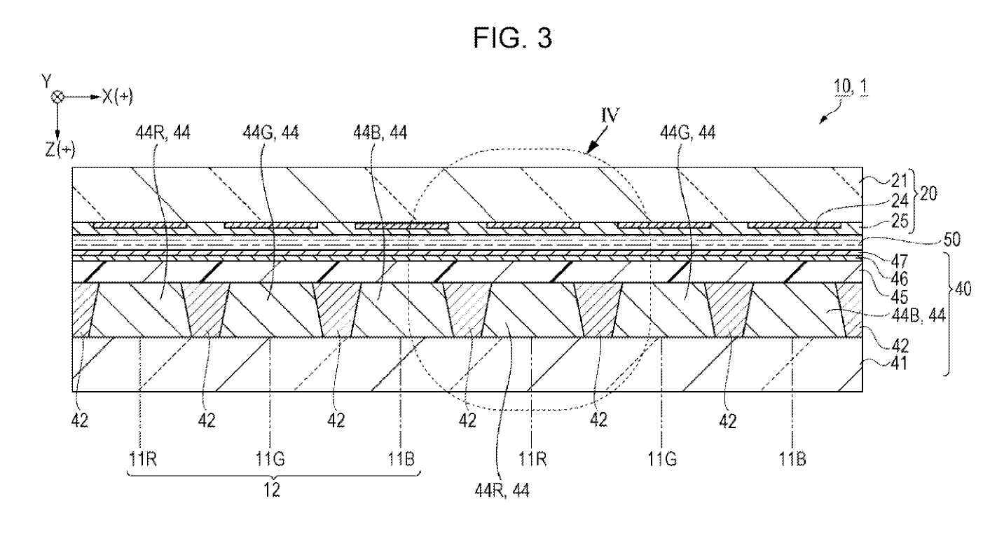

The display panel 5 is a display body providing full-color display, and includes an element substrate 20, a counter substrate 40, etc. The element substrate 20 and the counter substrate 40 are bonded with each other by a sealing material (not shown) that is formed at a peripheral edge, and a predetermined gap is formed therebetween. The gap between the element substrate 20 and the counter substrate 40 is filled with liquid crystals 50 (refer to FIG. 3).

The element substrate 20 includes a display area 10 where the pixels 11 are arranged in a matrix form in the X axis direction and the Y axis direction, driving circuits (scanning line driving circuits 35, and a data line driving circuit 36) that drive the pixels 11, a test circuit 37, etc. The scanning line driving circuit 35 is disposed between an outer edge (side) of the element substrate 20 extending in the Y axis direction and the display area 10, the display area 10 being interposed between the scanning line driving circuits. The data line driving circuit 36 is disposed between a side of a face of the element substrate 20 to which the flexible substrate 55 is attached and the display area 10. The test circuit 37 is disposed between a side of the element substrate 20 extending in the X axis direction from the Y axis (+) direction side and the display area 10.

One side of the element substrate 20 projects from the counter substrate 40, and the flexible substrate 55 is attached to the projected area. A driver IC 56 is provided in the flexible substrate 55. A signal that drives the scanning line driving circuits 35, the data line driving circuit 36, and the test circuit 37 is supplied to the element substrate 20.

The counter substrate 40 is an example of a color filter substrate of the invention, and a plurality of color layers (color filter layers) 44 are disposed therein (refer to FIG. 3).

Also, a polarizing plate (not shown) is bonded to a surface of the element substrate 20 on the Z axis (−) direction side, and a surface of the counter substrate 40 on the Z axis (+) direction side.

As shown in FIG. 2, the display device 1 includes a plurality of scanning lines 31 and a plurality of data lines 32 that are insulated from and orthogonal to each other at least in the display area 10, and capacitor lines 33. In the display area 10, the scanning lines 31 and the capacitor lines 33 extend in the X axis direction, and the data lines 32 extend in the Y axis direction.

An area partitioned by the scanning line 31, the capacitor line 33, and the data line 32 is the pixel 11. The pixel 11 includes a pixel electrode 24, a thin film transistor (hereinafter referred to as TFT) 22, a storage capacitor 23, etc.

The scanning line 31 is electrically connected to a gate electrode of the TFT 22, and the data line 32 is electrically connected to a source electrode of the TFT 22. The pixel electrode 24 is electrically connected to a drain electrode of the TFT 22.

The data line 32 is connected to the data line driving circuit 36 (refer to FIG. 1), and image signals D1, D2 . . . Dn are supplied to the pixel 11 from the data line driving circuit 36. The scanning line 31 is connected to the scanning line driving circuit 35 (refer to FIG. 1), and scanning signals SC1, SC2 . . . SCm are supplied to the pixel 11 from the scanning line driving circuit 35.

The image signals D1 to Dn may be supplied from the data line driving circuit 36 in this order and in a linear sequence with respect to the data lines 32, or may be supplied by group with respect to the plurality of data lines 32 that are adjacent to each other. The scanning signals SC1, SC2 . . . SCm are supplied from the scanning line driving circuit 35 in a pulsed manner, in a linear sequence, and at a predetermined timing with respect to the scanning lines 31.

The display device 1 is configured in such a manner that the image signals D1 to Dn supplied from the data line 32 are written in the pixel electrodes 24 while the TFT 22, which is a switching element, remains in an ON state for a certain period of time by an input of the scanning signals SC1 to SCm. The image signals D1 to Dn of a predetermined level that are written in the liquid crystals 50 via the pixel electrodes 24 are maintained for a certain period of time between the pixel electrodes 24 and counter electrodes 46 that are disposed oppositely to the pixel electrodes 24 via the liquid crystals 50.

In order to prevent the maintained image signals D1 to Dn from overflowing, the storage capacitor 23 is connected in parallel with a liquid crystal capacitor formed between the pixel electrode 24 and the counter electrode 46. The storage capacitor 23 is provided between the drain electrode of the TFT 22 and the capacitor line 33.

### Overview of Display Panel

FIG. 3 is a cross-sectional view of a display panel taken along line III-III of the display area of FIG. 1. Hereinafter, an overview of the display panel will be described referring to FIG. 3.

As shown in FIG. 3, in the display panel 5, the element substrate 20 and the counter substrate 40 are stacked in the Z axis (+) direction, and the gap between the element substrate 20 and the counter substrate 40 is filled with the liquid crystals 50.

In the Z axis (+) direction of the element substrate 20, an element substrate main body 21, the pixel electrode 24, and an alignment film 25 are stacked in order.

The element substrate main body 21 is a transistor substrate in which the scanning line 31, the data line 32, the capacitor line 33, the scanning line driving circuit 35, the data line driving circuit 36, the test circuit 37, the TFT 22, the storage capacitor 23 and the like are formed by known techniques in a light transmitting substrate of quartz, alkali-free glass, etc. The pixel electrode 24 is formed of a light transmitting conductive material such as indium tin oxide (ITO). The alignment film 25 is an organic alignment film formed of, for example, polyimide, and is disposed to cover the display area 10.

In the Z axis (−) direction of the counter substrate 40, a counter substrate main body 41, a light blocking portion 42, the color filter layer 44, a protective film 45, the counter electrode 46, and an alignment film 47 are stacked in order.

The counter substrate main body 41, which is an example of the substrate of the invention, is configured of a light transmitting substrate of quartz, alkali-free glass or the like, and transmits light. The light blocking portion 42 is formed of a light reflecting material, and aluminum is used in the present embodiment. An aluminum alloy, silver, a silver alloy, tungsten silicide or the like can be used in the light blocking portion 42 instead of aluminum. When viewed from the Z axis direction, the light blocking portion 42 planarly overlaps a peripheral edge of the pixel electrode 24, and is a black matrix that blocks light to the peripheral edge of the pixel electrode 24 and an area where the pixel electrode 24 is not formed.

The color filter layer 44 is the color layer that colors light from a light source, and is disposed in an area where the light blocking portion 42 is not formed. In the display area 10, a red color filter layer 44R, a green color filter layer 44G, and a blue color filter layer 44B are disposed in the R pixel 11R, the G pixel 11G, and the B pixel 11B, respectively. The protective film 45 is formed of, for example, a light transmitting resin layer, and is planarized. The counter electrode 46 is formed of a light transmitting conductive material such as (ITO). The alignment film 47 is an organic alignment film formed of, for example, polyimide, and is disposed to cover the display area 10.

The display device 1 described above is a transmission type device, and normally black mode display that is dark display is provided when the pixels 11 are not driven.

### Overview of Counter Substrate

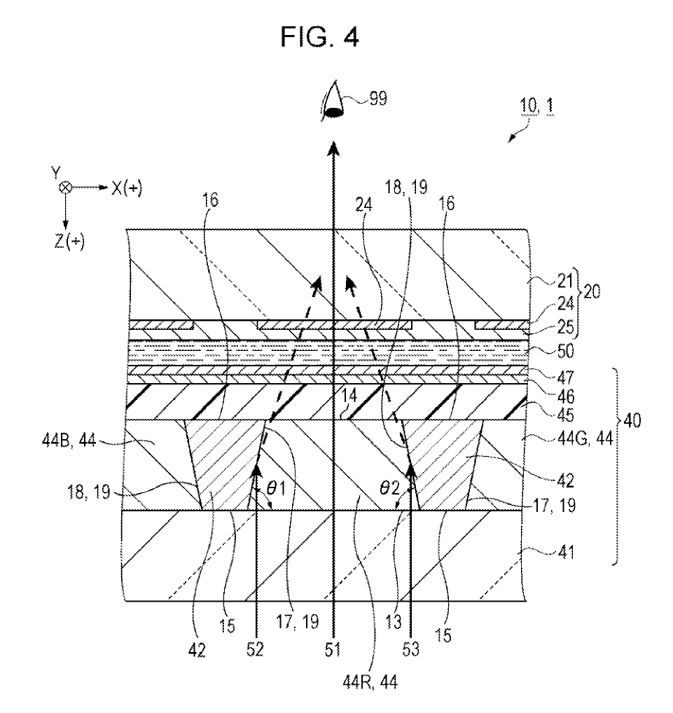

FIG. 4 is a cross-sectional view of the display panel showing area IV surrounded by a dashed line of FIG. 3. The invention is characterized by the counter substrate 40. Hereinafter, an overview of the counter substrate 40 will be described referring to FIG. 4 along with features of the invention.

As shown in FIG. 4, the blue color filter layer 44B, the red color filter layer 44R, and the green color filter layer 44G are disposed in order toward the X axis (+) direction. The red color filter layer 44R, which is disposed in the middle of the drawing is an example of a first color filter layer of the invention. The blue color filter layer 44B and the green color filter layer 44G, which are adjacent to the red color filter layer 44R, are examples of a second color filter layer of the invention. Furthermore, a contact surface of the red color filter layer 44R which is in contact with the counter substrate main body 41 is an example of a first surface of the invention, and is referred to as a first CF contact surface 13 hereinafter. A contact surface of the red color filter layer 44R which is in contact with the protective film 45 is an example of a second surface of the invention, and is referred to as a second CF contact surface 14 hereinafter. Also, a contact surface of the red color filter layer 44R which is in contact with the light blocking portion 42 is an example of a side surface of the invention, and is referred to as a CF side surface 19 hereinafter.

The red color filter layer 44R includes the first CF contact surface 13, the second CF contact surface 14 that opposes the first CF contact surface 13, and the CF side surface 19 that crosses the first CF contact surface 13 and the second CF contact surface 14. An angle between the CF side surface 19 and the first CF contact surface 13 is an acute angle. The angle is approximately 80° in the present embodiment.

The light blocking portions 42 are disposed between the red color filter layer 44R and the blue color filter layer 44B, and between the red color filter layer 44R and the green color filter layer 44G, in such a manner as to be in contact with the respective color filter layers 44 (44R, 44B, and 44G). Contact surfaces of the light blocking portion 42 which are in contact with the red color filter layer 44R are examples of a wall surface of the invention. Hereinafter, the contact surface on the X axis (−) direction side is referred to as a first LS wall surface 17, and the contact surface on the X axis (+) direction side is referred to as a second LS wall surface 18. In other words, the first LS wall surface 17 and the second LS wall surface 18 are examples of the wall surface of the invention. A contact surface of the light blocking portion 42 which is in contact with the counter substrate main body 41 is an example of a third surface of the invention, and is referred to as a first LS contact surface 15 hereinafter. A contact surface of the light blocking portion 42 which is in contact with the protective film 45 is an example of a fourth surface of the invention, and is referred to as a second LS contact surface 16 hereinafter.

The light blocking portion 42 includes the first LS contact surface 15, the second LS contact surface 16 that opposes the first LS contact surface 15, and the first LS wall surface 17 and the second LS wall surface 18 that cross the first LS contact surface 15 and the second LS contact surface 16. The first LS contact surfaces 15 are disposed between the red color filter layer 44R and the blue color filter layer 44B, and between the red color filter layer 44R and the green color filter layer 44G.

In the light blocking portion 42, an angle θ1 between the first CF contact surface 13 and the first LS wall surface 17, and an angle θ2 between the first CF contact surface 13 and the second LS wall surface 18 are approximately 80° (acute angle), equal to the angle between the CF side surface 19 and the first CF contact surface 13. The reverse tapered light blocking portion 42, in which the angles θ1 and θ2 are 80°, can be formed by a dry etching method using known techniques.

The color filter layer 44 is formed by filling an area surrounded by the light blocking portion 42 and the first CF contact surface 13 using ink jet, etc. The light blocking portion 42 has a role of inhibiting the color filter layer 44 filled with each pixel 11 from flowing to the adjacent pixels 11. In the present embodiment, the light blocking portion 42 and the color filter layer 44 have the same film thickness (length in the Z axis direction). The film thickness is approximately 1.5 μm.

For example, a configuration in which the color filter layer 44 whose volume is larger than the volume of the area surrounded by the light blocking portion 42 is filled and the film thickness of the color filter layer 44 is larger than the film thickness of the light blocking portion 42 is possible. In such configuration, the second CF contact surface 14 swells from the second LS contact surface 16, and is formed to cover an end surface of the second LS contact surface 16. Also, the second LS contact surface 16 opposes the first LS contact surface 15, and is wider than the first LS contact surface 15. Therefore, even if the filled color filter layer 44 overflows, the overflow is stopped by the second LS contact surface 16, and mixing (color mixing) with the adjacent color filter layer 44 is prevented.

In the drawing, an arrow to which reference numeral 51 is attached is display light that is emitted from the light source (not shown), passes through the display panel 5, travels toward an observer 99, and is observed by the observer 99. In this manner, the light that is emitted from the light source is the display light passing (traveling) in a direction from the first CF contact surface 13 toward the second CF contact surface 14, passing through the pixel electrode 24, emitted in the Z axis (−) direction, and observed by the observer 99.

In the drawing, a solid arrow to which reference numeral 52 is attached is light that is incident upon the first LS wall surface 17, and is referred to as incident light 52 hereinafter. An arrow to which reference numeral 53 is attached is light that is incident upon the second LS wall surface 18, and is referred to as incident light 53 hereinafter.

The light blocking portion 42 is formed of aluminum, and thus the first LS wall surface 17 and the second LS wall surface 18 are light reflective. Therefore, as shown with a dashed arrow, the incident light 52 that is incident from the first CF contact surface 13 is reflected toward the second CF contact surface 14 by the first LS wall surface 17. Also, as shown with a dashed arrow, the incident light 53 that is incident from the first CF contact surface 13 is reflected toward the second CF contact surface 14 by the second LS wall surface 18. Therefore, the light reflected by the first LS wall surface 17 and the light reflected by the second LS wall surface 18 travel in the direction from the first CF contact surface 13 toward the second CF contact surface 14 to become part of the display light observed by the observer 99 so that brightness of the display light can be increased.

If the angle θ1 between the first CF contact surface 13 and the first LS wall surface 17 and the angle θ2 between the first CF contact surface 13 and the second LS wall surface 18 are decreased, an area of the first LS contact surface 15 decreases, and an area of the second LS contact surface 16 increases. As a result, an area of the second CF contact surface 14, that is, an area through which the light emitted toward the observer 99 passes decreases, and there is a case where the brightness of the light (display light) observed by the observer 99 decreases. Furthermore, the light reflected by the first LS wall surface 17 and the light reflected by the second LS wall surface 18 spread in a transverse direction (X axis direction), and it is difficult for the lights to travel toward the observer 99. In this manner, if the angles θ1 and θ2 are decreased, there is a concern that the brightness of the display light observed by the observer 99 could decrease. Therefore, it is preferable that the angles θ1 and θ2 be at least 75°.

Also, if the angles θ1 and θ2 are increased, the amount (intensity) of the incident light 52 that is incident upon the first LS wall surface 17 and the amount of the incident light 53 that is incident upon the second LS wall surface 18 decrease, and the light reflected by the first LS wall surface 17 and the light reflected by the second LS wall surface 18 become weak. Therefore, it is preferable that the angles θ1 and θ2 be less than 85°. If the angles θ1 and θ2 are larger than 85°, the reflected light described above become weak, and the brightness of the display light observed by the observer 99 increases only slightly.

Therefore, it is preferable that the angle θ1 between the first CF contact surface 13 and the first LS wall surface 17 and the angle θ2 between the first CF contact surface 13 and the second LS wall surface 18 be between 75° and 85°. Also, the angles θ1 and θ2 do not have to be controlled to be between 75° and 85° in the entire areas of the light blocking portion 42, but the angles θ1 and θ2 may be between 75° and 85° in the main areas of the light blocking portion 42. In other words, a light blocking film may include an inclined area in which the angles θ1 and θ2 are between 75° and 85°.

As described above, in the present embodiment, the following effects can be obtained.

The first LS wall surface 17 and the second LS wall surface 18 are light reflective, and are inclined at an acute angle (approximately 80°) between the first CF contact surfaces 13. Therefore, the light that is incident from the first CF contact surface 13 can travel in the direction toward the second CF contact surface 14 as part of the display light observed by the observer 99, and thus the brightness of the display light can be increased.

### Second Embodiment

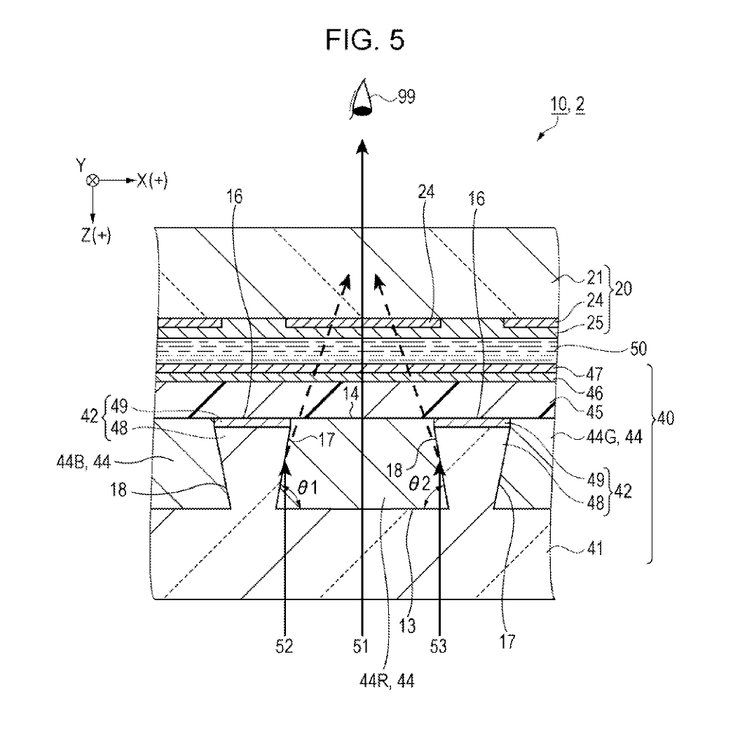

FIG. 5 is a cross-sectional view of a display device according to a second embodiment. FIG. 5 corresponds to FIG. 4.

A configuration of a display device 2 according to the second embodiment is the same as the configuration of the first embodiment with the exception of the light blocking portion 42 that is a component of the counter substrate 40. Hereinafter, the display device 2 according to the second embodiment will be described referring to FIG. 5, focusing on the difference between the first embodiment and the second embodiment. Like reference numerals in the drawing denote like elements, and duplicate description will be omitted.

### Overview of Counter Substrate

The counter substrate main body 41, which is an example of the substrate of the invention, is formed of quartz. The light blocking portion 42 is configured of an opaque film 49, and a convex portion 48 that is disposed between the opaque film 49 and the counter substrate main body 41. The opaque film 49 uses aluminum, and can use a metal material other than aluminum such as tungsten silicide. The convex portion 48 is formed of quartz. The convex portion 48 is formed by etching the counter substrate main body 41, and the convex portion 48 and the counter substrate main body 41 are integrated with each other. The light blocking portion 42 can be formed by continuously etching the aluminum forming the opaque film 49 and the material forming the counter substrate main body 41 by a known dry etching method in which the same resist is masked. A refractive index of the quartz forming the convex portion 48 is approximately 1.5, and a refractive index of the color filter layer 44 is approximately between 1.6 and 1.7. The convex portion 48 is formed of a material whose refractive index is lower than the refractive index of the color filter layer 44.

The opaque film 49 is an example of a light blocking layer that blocks light of the invention. The convex portion 48 is an example of a low refractive index layer whose refractive index is lower than the refractive index of the color filter layer of the invention.

In the present embodiment, a contact surface of the convex portion 48 which is in contact with the red color filter layer 44R on the X axis (−) direction side is the first LS wall surface 17, and a contact surface of the convex portion 48 which is in contact with the red color filter layer 44R on the X axis (+) direction side is the second LS wall surface 18. The angle θ1 between the first CF contact surface 13 and the first LS wall surface 17 and the angle θ2 between the first CF contact surface 13 and the second LS wall surface 18 are acute angles, both of which are approximately 80°.

The convex portion 48 and the red color filter layer 44R have different refractive indexes, and thus interface reflection occurs on an interface between the convex portion 48 and the red color filter layer 44R. On the X axis (−) direction side of the red color filter layer 44R, the incident light 52 that is incident upon the first LS wall surface 17 is reflected by the first LS wall surface 17 in the direction toward the second CF contact surface 14. On the X axis (+) direction side of the red color filter layer 44R, the incident light 53 that is incident upon the second LS wall surface 18 is reflected by the first LS wall surface in the direction toward the second CF contact surface 14.

In the present embodiment, the same effects as the effects of the first embodiment can be obtained. In other words, the light that is incident upon the first CF contact surface 13 can be reflected in the direction toward the second CF contact surface 14 by the first LS wall surface 17 and the second LS wall surface 18 so that the brightness of the display light observed by the observer 99 is increased.

Furthermore, since the convex portion 48 that is the low refractive index layer is integrated with the counter substrate main body 41, peeling by, for example, a mechanical shock is prevented, and the convex portion has excellent mechanical strength.

Also, the convex portion 48 that is the low refractive index layer may be formed by etching a low refractive index film which is deposited by a method such as chemical vapor deposition (CVD) or sputtering, instead of quartz, using known techniques. The low refractive index film can use, for example, silicon oxide and magnesium fluoride.

### Third Embodiment

### Overview of Display Device

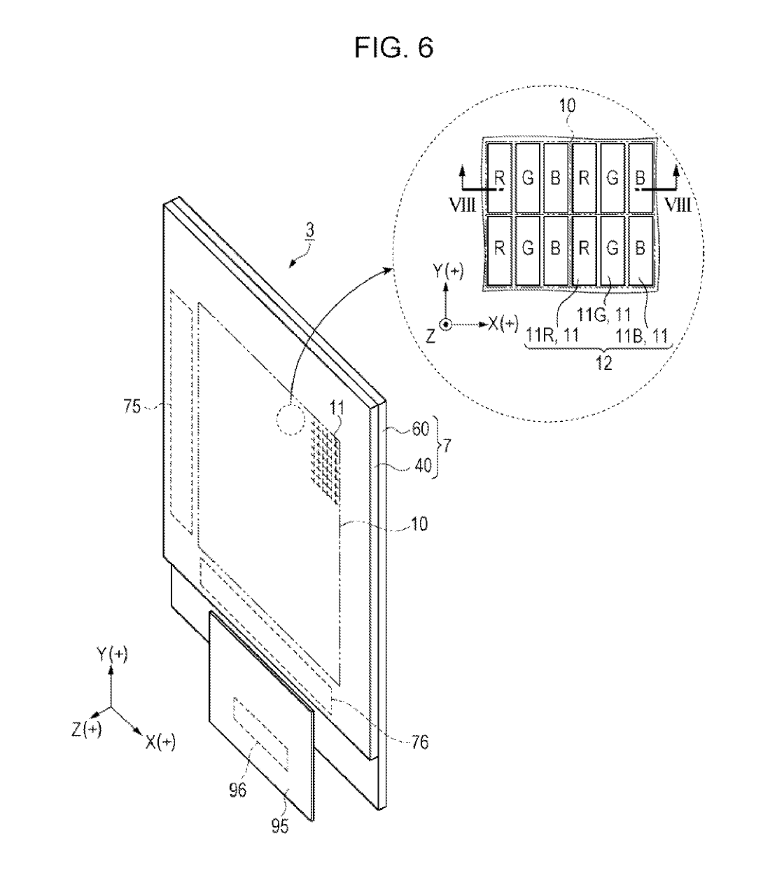

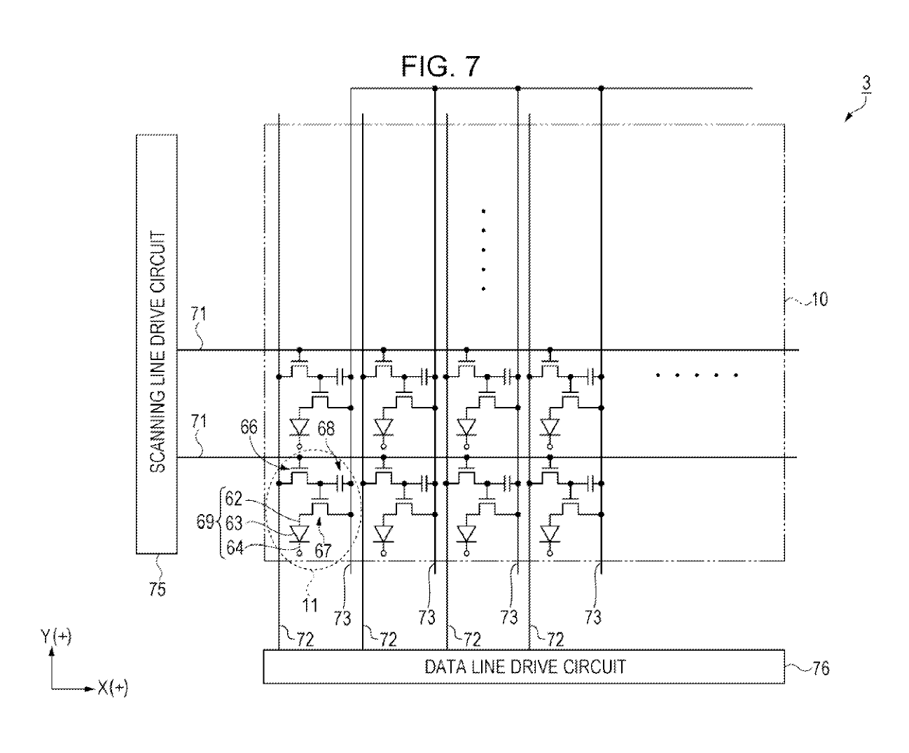

FIG. 6 is a perspective view showing a configuration of a display device according to a third embodiment. FIG. 7 is an equivalent circuit diagram showing an electrical configuration of a display area of the display device according to the third embodiment.

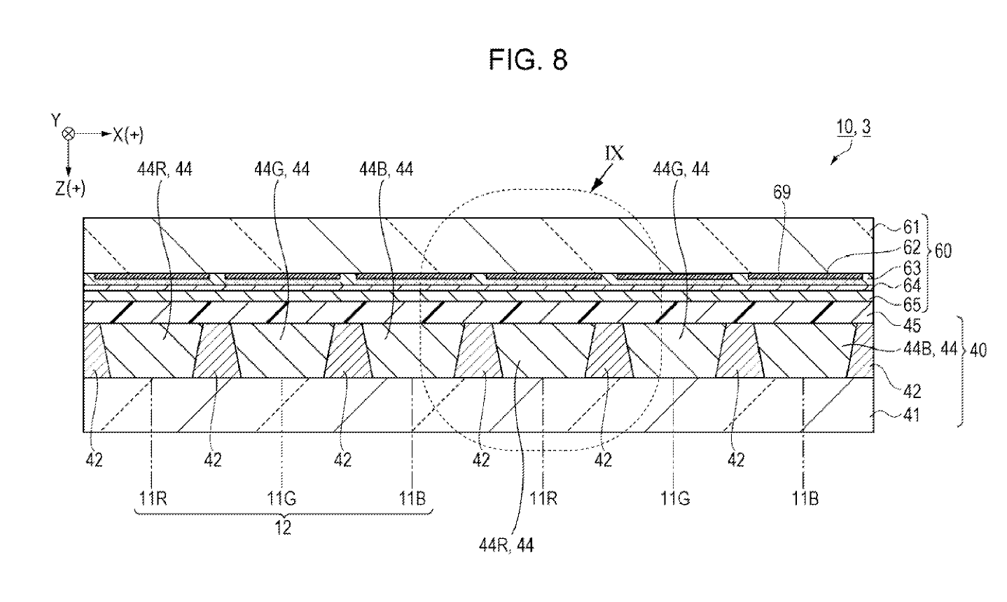

A display device 3 according to the third embodiment is an example of the electro-optical device, and is a self-luminous organic electroluminescence display device in which the pixels 11 including light emitting elements 69 (refer to FIG. 8), which will be described later, are arranged in a matrix form. The display device 1 according to the first embodiment is a non-luminous liquid crystal display device. The difference between the first embodiment and the third embodiment lies herein.

Hereinafter, the display device 3 according to the third embodiment will be described, focusing on the difference between the first embodiment and the third embodiment. Like reference numerals in the drawing denote like elements, and duplicate description will be omitted. First, an overview of the display device 3 will be described referring to FIGS. 6 and 7.

As shown in FIG. 6, the display device 3 is configured of a display panel 7, a flexible substrate 95, etc. As shown enlarged in the upper right section of FIG. 6, in the display area 10, the pixels (R pixels) 11R emitting red light, the pixels (G pixels) 11G emitting green light, and the pixels (B pixels) 11B emitting blue light are arranged in a stripe form. The three pixels 11 corresponding to the R pixel 11R, the G pixel 11G, and the B pixel 11B form the display unit 12 to provide full-color display.

The display panel 7 is a self-luminous display body providing full-color display, and includes a light emitting substrate 60, the counter substrate 40, etc. Also, the light emitting substrate 60 and the counter substrate 40 are bonded with each other by a light transmitting resin (not shown).

The light emitting substrate 60 includes the display area 10 where the pixels 11 are arranged in a matrix form in the X axis direction and the Y axis direction, driving circuits (scanning line driving circuits 75, and a data line driving circuit 76) that drive the pixels 11, etc. The scanning line driving circuit 75 is disposed between a side of the light emitting substrate 60 extending in the Y axis direction and the display area 10, and the data line driving circuit 76 is disposed between a side of a face of the light emitting substrate 60 to which the flexible substrate 95 is attached and the display area 10.

The counter substrate 40 is a color filter substrate where color layers (color filters) are formed at positions that correspond to the respective pixels 11 described above.

One side of the light emitting substrate 60 projects from the counter substrate 40, and the flexible substrate 95 is attached to the projected area. A driver IC 96 is provided in the flexible substrate 95. A signal or a power source and the like that drives the scanning line driving circuit 75 and the data line driving circuit 76 are supplied to the light emitting substrate 60.

As shown in FIG. 7, in the display area 10, a plurality of scanning lines 71 are disposed in such a manner as to extend in the X axis direction, and a plurality of data lines 72 and a plurality of power supply lines 73 are disposed in such a manner as to extend in the Y axis direction. The scanning lines 71 are connected to the scanning line driving circuit 75, and the data lines 72 are connected to the data line driving circuit 76. The scanning line 71 and the data line 72 cross each other, and the pixel 11 is formed in an area partitioned by the scanning line 71 and the data line 72.

A switching TFT 66, a storage capacitor 68, a driver TFT 67, the light emitting element 69 and the like are formed in the pixel 11. A scanning signal is supplied from the scanning line driving circuit 75 to a gate electrode of the switching TFT 66 via the scanning line 71. When the switching TFT 66 is in an ON state, a signal is supplied to the storage capacitor 68 from the data line driving circuit 76 via the data line 72 and the switching TFT 66. The signal maintained by the storage capacitor 68 is supplied to a gate electrode of the driver TFT 67. When the driver TFT 67 is in an ON state, an electric current flows to a pixel electrode 62 from the power supply line 73 via the driver TFT 67, and voltage (potential) Vp of the pixel electrode 62 changes.

The light emitting element 69 is configured of the pixel electrode 62, a light emitting functional layer 63, and the counter electrode 64. Reference voltage (0V) that is less than the voltage Vp of the pixel electrode 62 is supplied to the counter electrode 64. The voltage Vp of the pixel electrode 62 is applied to the light emitting functional layer 63 between the pixel electrode 62 and the counter electrode 64. When the voltage Vp of the pixel electrode 62 is more than the minimum voltage (threshold voltage) emitted by the light emitting functional layer 63, the light emitting functional layer 63 emits light. Also, as the voltage Vp of the pixel electrode 62 increases, an electric current flowing in the light emitting element 69 increases, and brightness of the light emitted by the light emitting functional layer 63 increases.

### Overview of Display Panel

FIG. 8 is a cross-sectional view of a display panel taken along line VIII-VIII of the display area of FIG. 6. FIG. 8 corresponds to FIG. 3.

As shown in FIG. 8, the light substrate 60 and the counter substrate 40 are stacked in order in the Z axis (+) direction. The light emitting substrate main body 61, the pixel electrode 62, the light emitting functional layer 63, the counter electrode 64, and the sealing layer 65 are stacked in order in the Z axis (+) direction of the light emitting substrate 60.

The light emitting substrate main body 61 is a transistor substrate in which the scanning line 71, the data line 72, the power supply line 73, the scanning line driving circuit 75, the data line driving circuit 76, the switching TFT 66, the storage capacitor 68, the driver TFT 67 (refer to FIG. 7) and the like are formed by known techniques in an insulated substrate of quartz, alkali-free glass, etc.

The pixel electrode 62 is an electrode that supplies a hole to the light emitting functional layer 63. The pixel electrode 62 is light reflective, and is formed of a metal material such as aluminum.

The light emitting functional layer 63 is formed to cover the display area 10. The light emitting functional layer 63 has an organic light emitting layer that emits white light when an electric current flows. Although not shown, the light emitting functional layer 63 may have layers such as a hole transport layer, a hole injection layer, an electron block layer, a hole block layer, an electron transport layer, and an electron injection layer in addition to the organic light emitting layer.

The counter electrode 64 is an electrode that supplies an electron to the light emitting functional layer 63, and is formed to cover the display area 10. The counter electrode 64 is a light reflective and a light transmitting (semi-transparent and semi-reflective) electrode, and is formed of an alloy of, for example, magnesium (Mg) and silver (Ag).

When viewed from the Z axis direction, an area where the pixel electrode 62 and the counter electrode 64 planarly overlap each other, that is, a shaded area in the drawing is an area where the light emitting element 69 is formed. Hereinafter, the area where the pixel electrode 62 and the counter electrode 64 planarly overlap each other (shaded area) is referred to as the light emitting element 69.

Light in the Z axis (+) direction and light in the Z axis (−) direction are emitted from the light emitting functional layer 63. The light in the z axis (−) direction emitted by the light emitting functional layer 63 is reflected by the pixel electrode 62, and travels in the Z axis (+) direction. Part of the light in the Z axis (+) direction emitted by the light emitting functional layer 63 is reflected in the Z axis (−) direction by the counter electrode 64, but the light is also reflected by the pixel electrode 62, and travels in the Z axis (+) direction. In this manner, the light in the Z axis (+) direction, that is, the light toward the counter substrate 40 is emitted from the light emitting element 69.

The sealing layer 65 is a passivation film that inhibits degradation of the light emitting functional layer 63 and the counter electrode 64, and is formed to cover the display area 10 by an insulating film of silicon nitride, silicon oxynitride or the like. The sealing layer 65 blocks oxygen and moisture, and inhibits degradation of the light emitting functional layer 63 and the counter electrode 64.

In the counter substrate 40, the red color filter layer 44R, the green color filter layer 44G, and the blue color filter layer 44B are disposed at positions corresponding to the R pixel 11R, the G pixel 11G, and the B pixel 11B, respectively.

### Overview of Display Panel

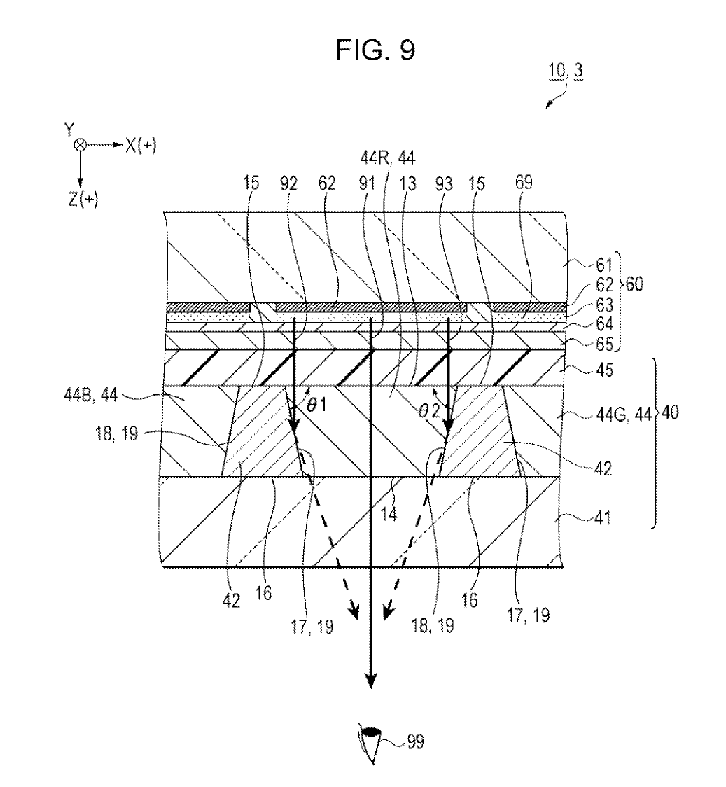

FIG. 9 is a cross-sectional view of the display panel showing area IX surrounded by a dashed line of FIG. 8. FIG. 9 corresponds to FIG. 4. Hereinafter, an overview of the counter substrate 40 will be described referring to FIG. 9 to clarify the features of the invention.

As shown above, the shaded area in the drawing is the light emitting element 69. An arrow to which reference numeral 91 is attached is light that is emitted by the light emitting element 69 and passes through the display panel 7. The light emitted by the light emitting element 69 is display light traveling in the Z axis (+) direction, passing through the color filter layer 44, emitted from the counter substrate main body 41, and observed by the observer 99.

In the present embodiment, the direction in which the light is emitted is opposite to the direction of the first embodiment, and thus the first CF contact surface 13, the second CF contact surface 14, the first LS contact surface 15, and the second LS contact surface 16 are disposed in an opposite direction to the first embodiment. In other words, the contact surface of the red color filter layer 44R which is in contact with the protective film 45 is the first CF contact surface 13, and the contact surface of the red color filter layer 44R which is in contact with the counter substrate main body 41 is the second CF contact surface 14. In addition, the contact surface of the light blocking portion 42 which is in contact with the protective film 45 is the first LS contact surface 15, and the contact surface of the light blocking portion 42 which is in contact with the counter substrate main body 41 is the second LS contact surface 16.

A solid arrow in the drawing to which reference numeral 92 is attached is light that is emitted by the light emitting element 69 and is incident upon the first LS wall surface 17, and is referred to as incident light 92 hereinafter. An arrow to which reference numeral 93 is attached is light that is emitted by the light emitting element 69 and is incident upon the second LS wall surface 18, and is referred to as incident light 93 hereinafter.

The light blocking portion 42 is formed of aluminum, and the first LS wall surface 17 and the second LS wall surface 18 are light reflective. Therefore, as shown with a dashed arrow, the incident light 92 that is incident from the first CF contact surface 13 is reflected toward the second CF contact surface 14 by the first LS wall surface 17. As shown with a dashed arrow, the incident light 93 that is incident from the first CF contact surface 13 is also reflected toward the second CF contact surface 14 by the second LS wall surface 18. Therefore, the light reflected by the first LS wall surface 17 and the light reflected by the second LS wall surface 18 also travel in the direction from the first CF contact surface 13 toward the second CF contact surface 14 to become part of the display light observed by the observer 99 so that the brightness of the display light can be increased.

In the present embodiment, the counter substrate main body 41 is in contact with the second CF contact surface 14 of the color filter layer 44, and is disposed on a side where the light (display light) is emitted. In the first and second embodiments, the counter substrate main body 41 is in contact with the first CF contact surface 13 of the color filter layer 44, and is disposed on a side where the light from the light source is incident. In this manner, the counter substrate main body 41 may be disposed in such a manner as to be in contact with any one of the first CF contact surface 13 or the second CF contact surface 14 of the color filter layer 44.

In the first to third embodiments, as shown above, the light blocking portion 42 has the first LS contact surface 15, the second LS contact surface 16 that opposes the first LS contact surface 15, and the first LS wall surface 17 and the second LS wall surface 18 that cross the first LS contact surface 15 and the second LS contact surface 16, and a surface on the side where the light from the light source is incident is the first LS contact surface 15. Furthermore, the first LS wall surface 17 and the second LS wall surface 18 reflect the incident light 52, 53, 92, and 93 to a side observed by the observer 99.

Also, the invention is not limited to the embodiments described above, and various modifications and improvements may be added to the embodiments described above. A modification example will be described hereinafter.

### First Modification Example

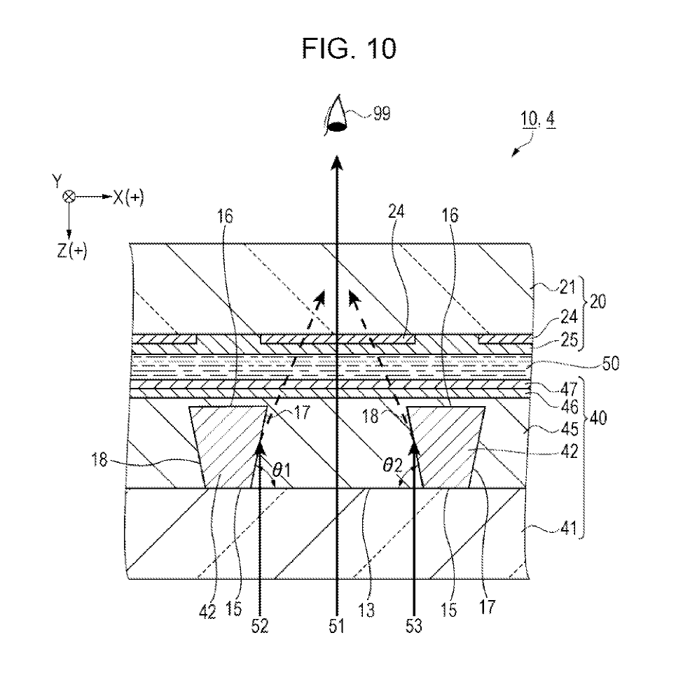

FIG. 10 is a cross-sectional view showing a display device according to a first modification example. FIG. 10 corresponds to FIG. 4.

A configuration of a display device 4 according the first modification example is the same as the configuration of the first embodiment with the exception that the color filter layer 44 is not formed. The display device 4 is a liquid crystal display device providing black-and-white display.

In the drawing, light shown with the solid arrow to which reference numeral 51 is attached is display light that passes through the counter substrate 40, the liquid crystal 50, and the element substrate 20, travels toward the observer 99 (toward the Z axis (−) direction), and is observed by the observer 99. The incident light 52 shown with the solid arrow to which reference numeral 52 is attached and the incident light 53 shown with the solid arrow to which reference numeral 53 is attached are reflected by the first LS wall surface 17 and the second LS wall surface 18, and travel in the direction shown with a dashed arrow. The reflected light also travel toward the observer 99 to become part of the display light observed by the observer 99 so that the brightness of the display light observed by the observer 99 can be increased.

In this manner, even with the black-and-white liquid crystal display device where the color filter layer 44 is not formed, the same effects as the first embodiment, that is, the increased brightness of the display light, can be obtained. Also, it is possible to apply this modification example to, for example, a liquid crystal display device that is a light modulator (light bulb) of a projector or a field sequential type liquid crystal display device as the display device 4 providing black-and-white display.

### Electronic Equipment

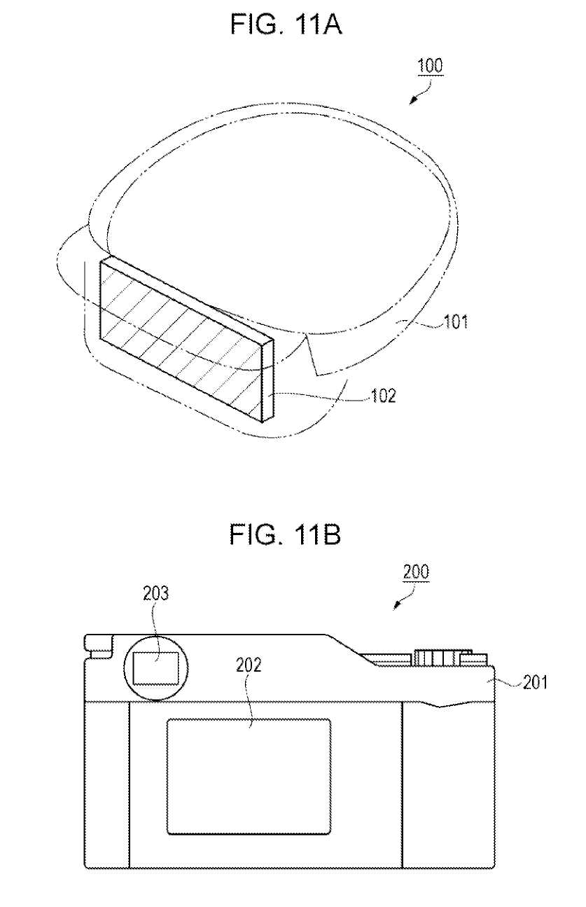

Hereinafter, the electronic equipment according to the embodiments will be described referring to FIGS. 11A and 11B. FIG. 11A is a perspective view of a head-mounted display (HMD), and FIG. 11B is a schematic view showing an overview of a digital camera.

As shown in FIG. 11A, an HMD 100 as the electronic equipment has an annular support portion 101 that is mounted on a head portion of an observer, and a display portion 102 that displays an image with respect to left and right eyes of the observer. Any of the display devices 1 to 4 according to the above embodiments or modification example is mounted on the display portion 102.

As shown in FIG. 11B, a digital camera 200 as another electronic equipment according to the embodiments includes a main body 201 that has an optical system such as an image capturing element. In the main body 201, a monitor 202 that displays a captured image and the like, and an electronic view finder 203 that recognizes objects are provided. Any of the display devices 1 to 4 according to the above embodiments or modification example is mounted on the electronic view finder 203.

Any of the display devices 1 to 4 according to the above embodiments or modification example is mounted on the display portion 102 and the electronic view finder 203, and thus it is possible to increase the brightness of the display light and to provide brighter display compared to a case where an electro-optical element manufactured using the related art is mounted.

Furthermore, the electro-optical device of the invention can be applied to display portions of various electronic equipment, such as a mobile computer, a digital video camera, in-vehicle equipment, audio equipment, and information terminal equipment, other than the HMD or digital camera described above.

The entire disclosure of Japanese Patent Application No. 2012-219139, filed Oct. 1, 2012 is expressly incorporated by reference herein.

What is claimed is:

1. A color filter substrate comprising:
a first color filter layer;
a second color filter layer; and
a light blocking portion that blocks light,
wherein the first color filter layer includes a first surface, a second surface opposing the first surface, and a side surface crossing the first surface and the second surface,
wherein an angle between the first surface and the side surface is an acute angle,
wherein the light passes in a direction toward the second surface from the first surface,
wherein the light blocking portion is disposed so as to be in contact with the side surface, and
wherein a wall surface of the light blocking portion that is disposed so as to be in contact with the side surface reflects the light entered from the first surface so that the light is directed toward the second surface.

2. The color filter substrate according to claim 1,
wherein the light blocking portion includes a third surface, a fourth surface opposing the third surface, and the wall surface crossing the third surface and the fourth surface, and
wherein the third surface is disposed between the first color filter layer and the second color filter layer.

3. The color filter substrate according to claim 1,
wherein a substrate is disposed so as to be in contact with any one of the first surface and the second surface, and
wherein the substrate transmits light.

4. The color filter substrate according to claim 1,
wherein the wall surface includes an area inclined at an angle of between 75° and 85° from the first surface.

5. The color filter substrate according to claim 1,
wherein the light blocking portion contains aluminum.

6. The color filter substrate according to claim 1,
wherein the light blocking portion includes a light blocking layer that blocks the light, and a low refractive index layer that has a refractive index which is lower than a refractive index of the first color filter layer and a refractive index of the second color filter layer.

7. The color filter substrate according to claim 1,
wherein the substrate contains quartz, and
wherein the light blocking portion includes a light blocking layer that blocks the light, and quartz formed by etching the substrate.

8. An electro-optical device comprising the color filter substrate according to claim 1.

9. An electro-optical device comprising the color filter substrate according to claim 2.

10. An electro-optical device comprising the color filter substrate according to claim 3.

11. An electro-optical device comprising the color filter substrate according to claim 4.

12. An electro-optical device comprising the color filter substrate according to claim 5.

13. An electro-optical device comprising the color filter substrate according to claim 6.

14. An electro-optical device comprising the color filter substrate according to claim 7.

15. Electronic equipment comprising the electro-optical device according to claim 8.

16. Electronic equipment comprising the electro-optical device according to claim 9.

17. Electronic equipment comprising the electro-optical device according to claim 10.

18. Electronic equipment comprising the electro-optical device according to claim 11.

19. Electronic equipment comprising the electro-optical device according to claim 12.

20. Electronic equipment comprising the electro-optical device according to claim 13.
